(19) United States
(12) Patent Application Publication
(10) Pub. No.: US 2005/0050195 A1
(43) Pub. Date: Mar. 3, 2005

(54) Control method for setting up operation time of wireless connection device

(75) Inventors: Chung-Hui Chen, Taipei (TW); Yu-Mei Hsu, Taipei (TW); Yu-Hua Hsu, Taipei (TW); Fu-Zen Hsieh, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 10/648,229

(22) Filed: Aug. 27, 2003

(51) Int. Cl. G06F 15/173

(52) U.S. Cl. 709/224; 719/321

(57) ABSTRACT

The present invention discloses a control method for setting up the operation time of a wire connection device by installing a detection control software in a driver program, and the detection control software sets up the detection operation time of the wireless connection device such that when a computer device is turned on, the detection control software controls the ON/OFF time of the wireless connection device according to the setup of the detection operation time through the driver program to avoid unnecessary waste of electric power and any possible risk to pathological changes caused by exposing our body under the electromagnetic waves for a long time.

### BACKGROUND OF THE INVENTION

1. Field of the Invention

The present invention relates to a control method for setting up the operation time of a wireless connection device.

2. Description of the Related Art

At present, most computer devices (such as notebook computer and, players) introduced by major computer manufacturers usually come with a wireless connection device (such as an infrared device or a Bluetooth device), and the wireless connection device is generally turned on at the time when the computer device is booted, so that the wireless connection device can start its detection and search within an effective transmission range. Unless users actively turn off the wireless connection device, the wireless connection device will unceasingly detect and search in all directions, and thus causing unnecessary waste of electric power. Furthermore, the electromagnetic wave constantly radiated from the wireless connection device may also cause a threat of our health.

Therefore, we urge to find a new invention in order to set the wireless connection device on at an appropriate time or in a certain fixed period, and actively turn on or shut down the wireless connection device. Such arrangement is definitely a great contribution to the extensive consumers.

In view of the aforesaid shortcomings, the present inventor aimed at the problem and started finding a way to make improvements and overcome the shortcomings. The present inventor based on years of experience accumulated from the engagement in the related industry conducted extensive research to resolve the aforementioned shortcomings and finally invented a control method for setting up the operation time of a wireless connection device in accordance with the present invention.

### SUMMARY OF THE INVENTION

The primary objective of the present invention is to install a detection control software in the driver program, and the detection control software can set up the detection operation time of the wireless connection device (e.g. from 8 am to 6 pm), such that when a computer device is turned on, the detection control software can control the ON/OFF time of the wireless connection device according to the setup of the detection operation time through the driver program in order to avoid unnecessary waste of electric power and any possible risk to pathological changes caused by exposing our body under the electromagnetic waves for a long time.

### BRIEF DESCRIPTION OF THE DRAWINGS

Other feat?ures and advantages of the present invention will become apparent in the following detailed description of the preferred embodiments with reference to the accompanying drawings, in which:

FIG. 1 is an illustrative diagram of the present invention.

FIG. 2 is a flowchart of a preferred embodiment of the present invention.

FIG. 3 is a flowchart of another preferred embodiment of the present invention.

### DETAILED DESCRIPTION OF THE PREFERRED EMBODIMENTS

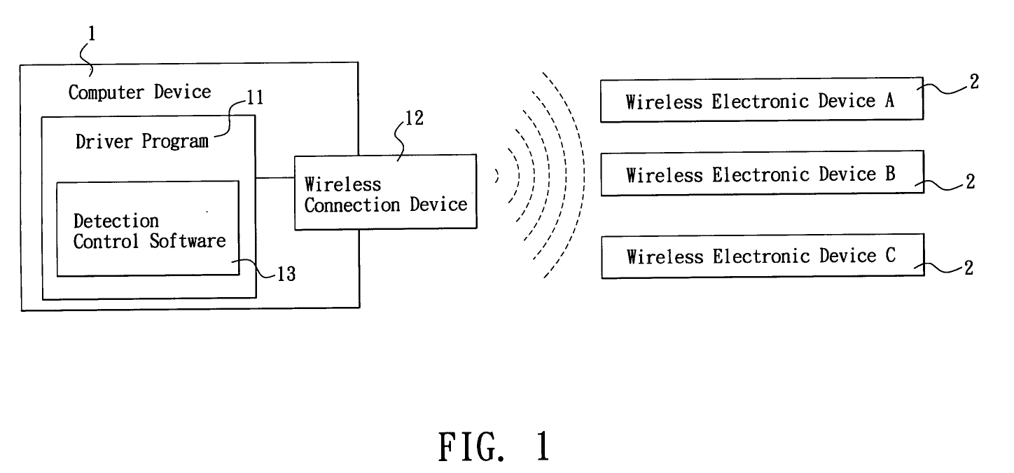

Please refer to FIG. 1 for the control method to set up the operation time of a wireless connection device 12 in accordance with the present invention. Such method sets a wireless connection device 12 and a driver program 11 on a computer device 1; wherein the driver program 11 has a detection control software 13, which can set up an operation time of the wireless connection device 12, such that when the computer device 1 is booted, the detection control software 13 can determine whether or not the internal clock of the computer device 1 has reached the detection operation time according to the setup value of the detection operation time. If yes, the wireless connection device 12 will be turned on immediately through the driver program 11, so that the wireless connection device 12 starts its detection within a limit distance of the search range. The wireless connection device 12 searches for any connectible wireless electronic device 2, and when the detection operation time ends, the detection control software 13 will turn off the wireless connection device 12 through the driver program 11.

By such ingenious idea of the present invention, unnecessary power consumption of the computer device 1 can be saved, and the impact of long-time exposure of radiation caused by the electromagnetic wave of the wireless connection device 12 on human body can be avoided. In addition, turning on and off the wireless connection device 12 at appropriate time can extend the life of use of the wireless connection device 12.

Please refer to FIG. 1 for the present invention, and the detection operation time can be divided into two operation modes:

(1) START/END Time: For example, two operation time can be set for a day, which are from 08:00 am to 10:00 am and from 16:00 pm to 18:00 pm respectively (Please refer to the preferred embodiment below).

(2) ON/OFF Operation Period: For example, when the computer device 1 is booted, it will also activate the wireless connection device 12, but the wireless connection device 12 will automatically shut down after 6 hours (please refer to the preferred embodiment below).

However, when the present invention is implemented, it is not limited to this, but the persons skilled in the art can make changes according to the characteristics of the present invention, which should be regarded as the so-called “control method for setting up the operation time of a wireless connection device 12” of the present invention. Two preferred embodiments of this invention are described as follows:

Please refer to FIG. 1 for a preferred embodiment of the present invention. The detection control software 13 can set at least one START time and at least one END time, such as from 08:00 am to 10:00 am and from 16:00 pm to 18:00 pm respectively for the wireless connection device 12. When the computer device 1 boots at 07:00 am, since the internal clock of the computer device 1 is still not up to the START time of the wireless connection device 12 yet, therefore the driver program 11 will not drive the wireless connection device 12. However, when the internal clock of the computer device 1 is up to the START time at 08:00 am, the detection control software 13 will immediately drive the wireless connection device 12 through the driver program 11, and when the internal clock of the computer device 1 is up to the time of 10:00 am, the detection control software 13 will immediately turn off the wireless connection device 12 until the internal clock of the computer device 1 reaches 16:00 pm. The detection control software 13 will immediately drive the wireless connection device 12 by the driver program 11. When the internal clock of the computer device 1 has reached 18:00 pm, the detection control software 13 will turn off the wireless connection device 12 again by the driver program 11.

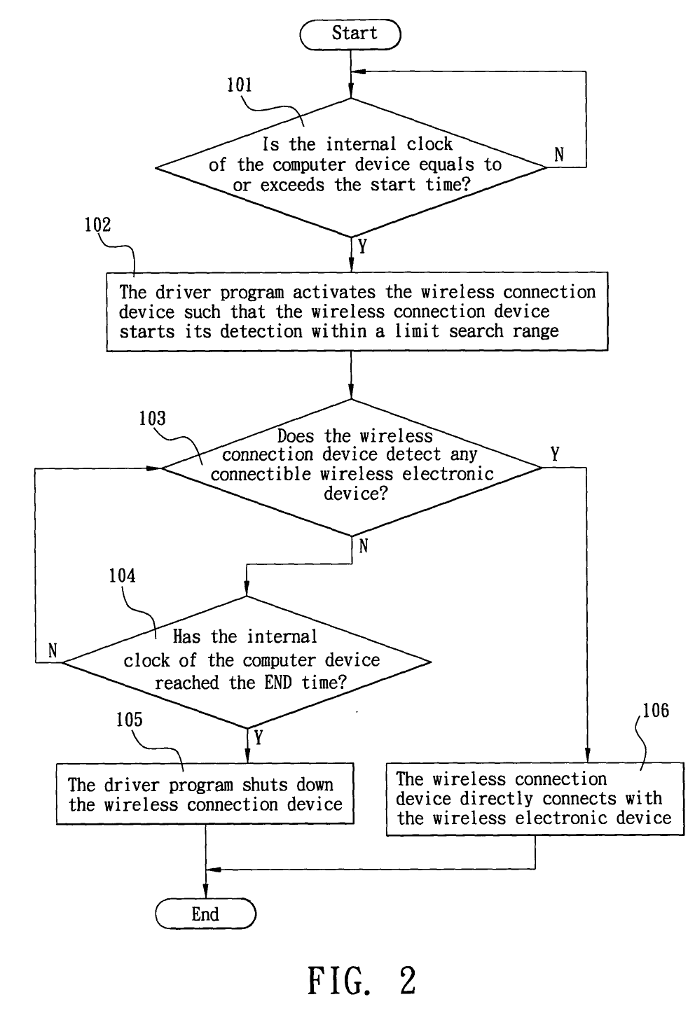

Please refer to FIGS. 1 and 2 for the ON state of the computer device 1. The detection control software 13 controls the flow of activating and ending the wireless connection device 12. Detailed procedure is given below (as illustrated in FIG. 2).

(101) Firstly, determine if the internal clock of the computer device 1 equals to or exceeds the START time in order to go to Step (102). If no, repeat Step (101);

(102) Activate the wireless connection device 12 by the driver program 11, so that the wireless connection device 12 starts detecting within the limited search range;

(103) determines whether or not the wireless connection device 12 has detected any wireless electronic device 2 for online connection of the wireless connection device 12. If yes, the wireless electronic device 2 is connected directly (as shown in Step (106); if no, go to Step (104));

(104) Determine whether or not the internal clock of the computer device 1 has reached the END time. If yes, go to Step (105); if no, go back to Step (103).

(105) finally, after the driving program 11 turns off the wireless connection device 12, the program is ended.

Please refer to FIG. 1 for another preferred embodiment of this invention. The detection operation time could be a START/END operation time (such that the wireless connection device 12 will be turned off 2 hours after the computer device 1 is turned on.) Therefore, when the computer device 1 boots at the START time (such as 09:00 am), the driver program 11 will simultaneously drive the wireless connection device 12, such that the wireless connection device 12 starts its detection within the limited searching range. When the START/END operation time ends (such as 11:00 am) and the computer device 1 is not connected to any wireless electronic device 2, the detection control software 13 immediately turns off the wireless connection device 12 through the driving program 11.

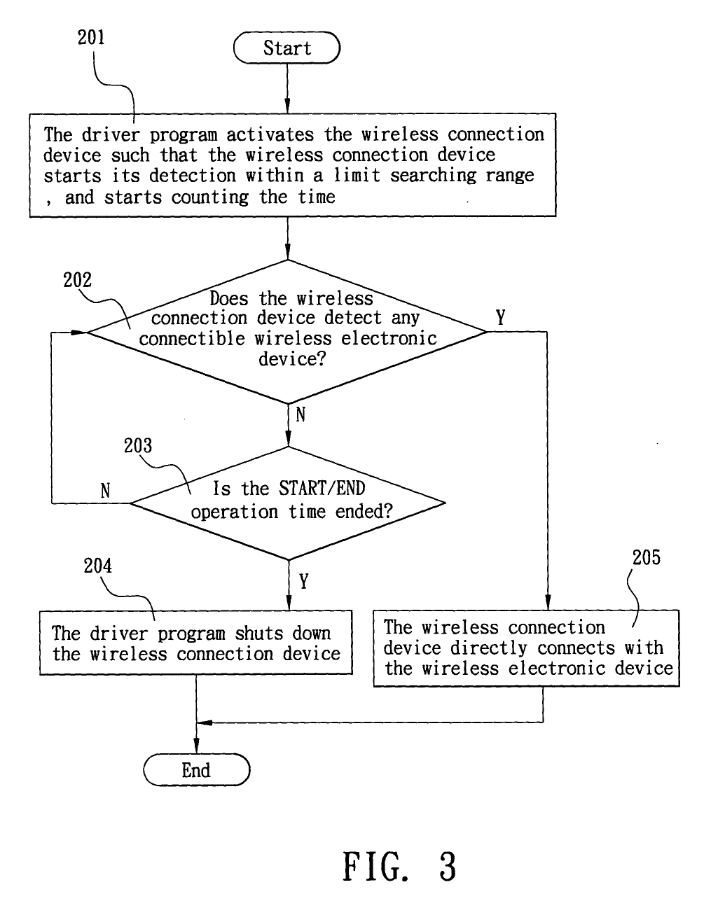

When the computer device 1 is booted at the START time, the detection control software 13 controls the flow of turning on and off the wireless connection device 12 as follows (see FIG. 3):

(201) Firstly, drive the wireless connection device 12 by the driver program 11, such that the wireless connection device 12 starts its detection within the limited searching range, and starts counting the time;

(202) Determine whether the wireless connection device 12 has detected any wireless electronic device 2 for online connection; if no, go to Step 203; if yes, directly connect with the wireless electronic device 2 (as shown in Step (205));

(203) Determine whether the START/END operating time period is ended; if yes, go to Step (204); if no, repeat Step (202);

(204) finally, after the driver program 11 turns off the wireless connection device 12, the program is ended.

Please refer to FIG. 1 for the preferred embodiment of this invention. The computer device 1 could be a notebook computer, a desktop computer, a personal digital assistant (PDA), or a mobile phone, and the wireless connection device 12 could be a wireless device complying with the infrared data association (IrDA) technology or a Bluetooth wireless communication technology.

While the invention has been described by means of a specific embodiment, numerous modifications and variations could be made thereto by those skilled in the art without departing from the scope and spirit of the invention set forth in the claims.

1. A control method for setting up operation time of wireless connection device, by installing a wireless connection device and a driver program to a computer device, wherein said driver program having a built-in detection control software for setting a detection operation time of said wireless connection device, such that when the computer device being booted, the computer device proceeds with the processing comprising the steps of:
(a) determining if the internal clock of said computer device reaching the start of the detection operation time according to a predetermined value of the detection operation time by using said detection control software;
(b) if the internal clock of said computer device reaching the start of the predetermined detection operation time, then enabling the driver program to activate said wireless connection device to detect within the limit distance of searching range and search for any wireless electronic device for online connection;
(c) the detection control software determining if the internal clock of said computer device reaching the end of the detection operation time according to the predetermined detection operation time;
(d) if the internal clock of said computer device reaching the end of the predetermined detection operation time, then the driver program of said detection control software shutting down said wireless connection device.

2. The control method for setting up operation time of wireless connection device of claim 1, wherein said detection operation time comprises an ON time and an OFF time, such that the detection control software controls the ON and OFF of said wireless connection device by the steps of:
(a) determining if the internal clock of said computer device reaching the ON time;
(b) if the internal clock of said computer device reaching the ON time, then the driver program activating said wireless connection device, such that the wireless connection device starting its detection within the limit distance of searching range and searching for any wireless electronic device for online connection;
(c) determining if said wireless connection device being connectible to any wireless electronic device;
(d) if said wireless connection device being not connectible to any wireless electronic device, then determining if the internal clock of said computer device reaching the OFF time;
(e) if the internal clock of said computer device reaching the OFF time, then said driver program shutting down said wireless connection device.

3. The control method for setting up operation time of wireless connection device of claim 2, wherein if said internal clock of the computer device has not reached the ON time, then said detection control software will repeatedly determine whether the internal clock of said computer device has reached the ON time until the internal clock of said computer device has reached the ON time, and then continue to proceed the next step of the procedure.

4. The control method for setting up operation time of wireless connection device of claim 2, wherein if said wireless connection device has detected a connectible wireless electronic device, then said wireless connection device will directly connect with said wireless electronic device.

5. The control method for setting up operation time of wireless connection device of claim 2, wherein if said internal clock of the computer device has not reached the END time, said detection control software will repeatedly determine whether said internal clock of the computer device has reached the END time until said internal clock of the computer device has reached the END time, and then continue to proceed the next step of the procedure.

6. The control method for setting up operation time of wireless connection device of claim 1, wherein said computer device simultaneously turns on the wireless connection device at the same time, such that after said wireless connection device has operated for a period of time, said wireless connection device will automatically shut down said wireless connection device by said driver program, wherein the operation time from activating said wireless connection device to shutting down said wireless connection each time equals to said detection operation time, so that when said computer device boots, said detection control software activates and shuts down said wireless connection device with the steps of:
(a) the driver program activates said wireless connection device, such that said wireless connection device starting the detection within a limited searching range and counting the time;
(b) determining whether or not said wireless connection device detecting a connectible wireless electronic device,
(c) if said wireless connection device not detecting any connectible wireless electronic device, then determining whether or not the ON/OFF time being ended;
(c) if the ON/OFF time being ended, then said driver program shutting down said wireless connection device.

7. The control method for setting up operation time of wireless connection device of claim 6, wherein said if said wireless connection device has detected a connectible wireless electronic device, then said wireless connection device directly connects with said wireless electronic device.

8. The control method for setting up operation time of wireless connection device of claim 6, wherein if said operation time has not ended, said detection control software will repeatedly determine such until said operation time has ended, and then said driver program will shut down said wireless connection device.

9. The control method for setting up operation time of wireless connection device of claim 1, wherein said wireless connection device is a wireless module complying with an infrared transmission technology.

10. The control method for setting up operation time of wireless connection device of claim 1, wherein said wireless connection device is a wireless module complying with a Bluetooth transmission technology.
